(19) United States
(12) Patent Application Publication
(10) Pub. No.: US 2010/0304070 A1
(43) Pub. Date: Dec. 2, 2010

(54) GLAZING

(75) Inventor: Provino Meles, Chieti (IT)

Correspondence Address: BUCHANAN, INGERSOLL & ROONEY PC, POST OFFICE BOX 1404, ALEXANDRIA, VA, 22313-1404, US

(73) Assignee: PILKINGTON ITALIA S.P.A., San Salvo, Chieti (IT)

(21) Appl. No.: 12/744,892

(22) PCT Filed: Nov. 27, 2008
(86) PCT No.: PCT/EP08/66361

§ 371 Date: May 26, 2010

(30) Foreign Application Priority Data
Nov. 27, 2007 (EP) 07425747.8

(51) Int. Cl. B60R 13/04; B32B 37/12; B23P 11/00; B60J 10/02; B32B 3/02

(52) U.S. Cl. 428/38; 156/60; 29/281.1

(57) ABSTRACT

A method of bonding a trim onto the edge of a frameless automotive glazing using an adhesive involves placing the glazing in a first position in which an edge of the glazing is free to receive a trim and locating a trim having adhesive applied to at least a portion thereof in contact with the glazing. The glazing is then pushed into a second position, deforming the glazing against the trim and the adhesive such that the trim bonds to the glazing. An apparatus for applying the trim is also described.

The present invention relates to a glazing having a trim mounted thereon, and a method of mounting the trim onto the glazing.

The aesthetic appearance of an automotive vehicle, such as a car, is a key factor in successful sales. A number of features contribute to the overall appearance of a vehicle, one of which is the trim associated with the doors and windows. Trims, such as chrome-finish or plastic strips, are often added to fixed windows by being mounted on the glazing itself, rather than on the body of the vehicle. Trims for openable glazings are provided on the vehicle door or body. The trims themselves do not provide a structural or mechanical function, unlike a metal or polymer frame surrounding a glazing, but give a desirable aesthetic finish.

There are several different ways in which such finishers can be mounted on or bonded to the surface of the glass. For example, when the glazing is encapsulated by a polymer frame around its periphery, the trim may be included in the mould used for the encapsulation, and therefore bonded to the glazing by the polymer frame. The trim may be bonded to the glazing by a layer or multiple points of adhesive along its length. Alternatively, the trim may be clipped to the edge of the glazing, either directly, or via a holder that is bonded to the glazing.

These methods are appropriate when the glazing will be fixed within a vehicle, such as a backlight fixed within a tailgate. However, for glazings that are openable and frameless (having neither a polymer nor a metal frame), such fixing methods may be unsuitable. An example of a frameless glazing is an opening side window, particularly those provided on convertible or coupe cars, where the glazing contacts the “B” pillar of the car directly, and does not sit within an enclosed frame forming part of the car door. One particular glazing where it is desirable to be able to mount a trim is on an opening backlight. Rather than being bonded to the frame of a tailgate, an opening backlight forms the entire opening portion of the rear of a vehicle. The glazing therefore fits snugly against the frame of the vehicle when closed, and is not provided with any form of polymer frame around its periphery. This therefore removes the option of being able to bond any trim to the glazing using this polymer frame.

Any trim must therefore be adhered or clipped to the glazing. Adhering the trim to the glazing requires the trim to be positioned exactly to ensure that the glazing closes correctly and fits snugly within the car body. However, a tolerance is required to take into account variations in the edge of the glazing to which the trim is applied. These variations may be from cutting, grinding or shaping. Therefore it is difficult to fit the trim exactly to the edge of the glazing. A further problem is regulating the amount of adhesive applied. If the same amount of adhesive is applied to the trim for each glazing, any variations in the shape of the edge of the glazing will either cause adhesive to escape from under the trim onto the glazing, or for there to be too little adhesive. Clipping the trim to the body is also difficult, as the trim itself, or holder to which the trim is clipped, needs to be able to withstand the tolerances in the shape of the edge of the glazing.

Therefore, if various trims and finishers are to be used successfully with openable glazings such as opening backlights, a method of mounting the trim onto the glazing, which is compatible with the tolerances required, needs to be found.

The present invention aims to address this problem by providing a method of bonding a trim onto the edge of a frameless automotive glazing using an adhesive, comprising: placing the glazing in a first position in which an edge of the glazing is free to receive a trim; locating a trim having adhesive applied to at least a portion thereof in contact with the glazing; pushing the glazing into a second position, deforming the glazing against the trim and the adhesive such that the trim bonds to the glazing. By using a two-stage process in positioning the glazing and trim, and then applying the trim to the edge of a frameless automotive glazing, any gap between the edge of the trim and the glazing can be minimised.

The adhesive may be pre-applied to the trim. Preferably, the method further comprises locating the trim in the region of the glazing, and applying the adhesive to the trim before locating the trim in contact with the glazing.

Preferably, the glazing is held in the first position by a applying a first set of vacuum suction cups. Preferably, the glazing is pushed into the second position by applying a second set of vacuum cups.

Preferably, the adhesive is a hot melt adhesive.

Preferably, the trim is held in position in contact with the glazing by vacuum suction.

Preferably, the glazing is a single-ply of glass.

The invention also provides an apparatus for applying a trim to the edge a frameless automotive glazing, comprising means for supporting and centring a frameless automotive glazing; at least one suction cup forming a first set for applying vacuum suction to the underside of the glazing to hold the glazing in a first position; at least one suction cup forming a second set for applying vacuum suction to the underside of the glazing to push the glazing into a second position; a recess for receiving a trim, the recess being provided with a plurality of vacuum suction holes for maintaining the position of the trim; and means for locating the trim onto the edge of the glazing.

By using two separate sets of suction cups to maintain the position of the glazing and to push it into a second position, in which it will be in contact with a trim, the gap between the edge of the trim and the glazing when fitted is minimised.

The invention also provides a glazing having a trim applied thereon using the above method, and a glazing having a trim as described above applied thereon using such a method.

The present invention will now be described by way of example only, and with reference to the accompanying drawings, in which:

FIG. 1 is a schematic pan view of a frameless glazing having a trim attached along one side;

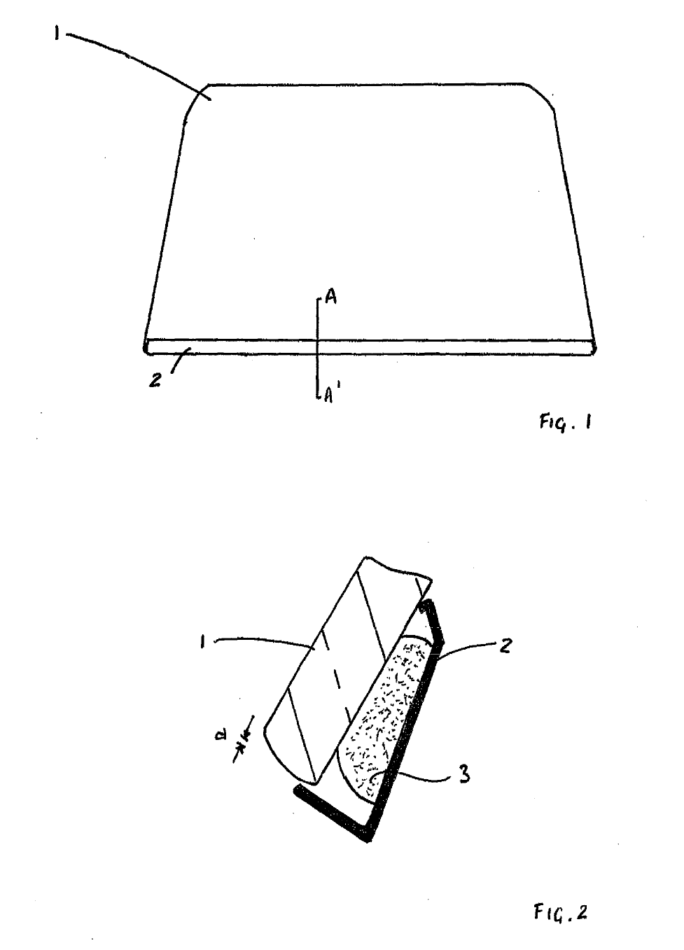

FIG. 2 is a schematic cross-section along the line A-A′ in FIG. 1;

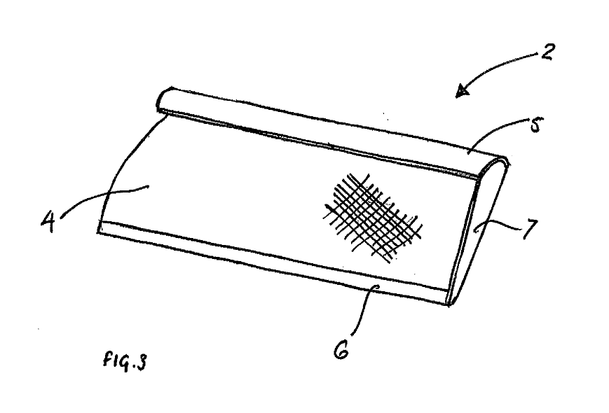

FIG. 3 is a schematic perspective view of the trim in more detail;

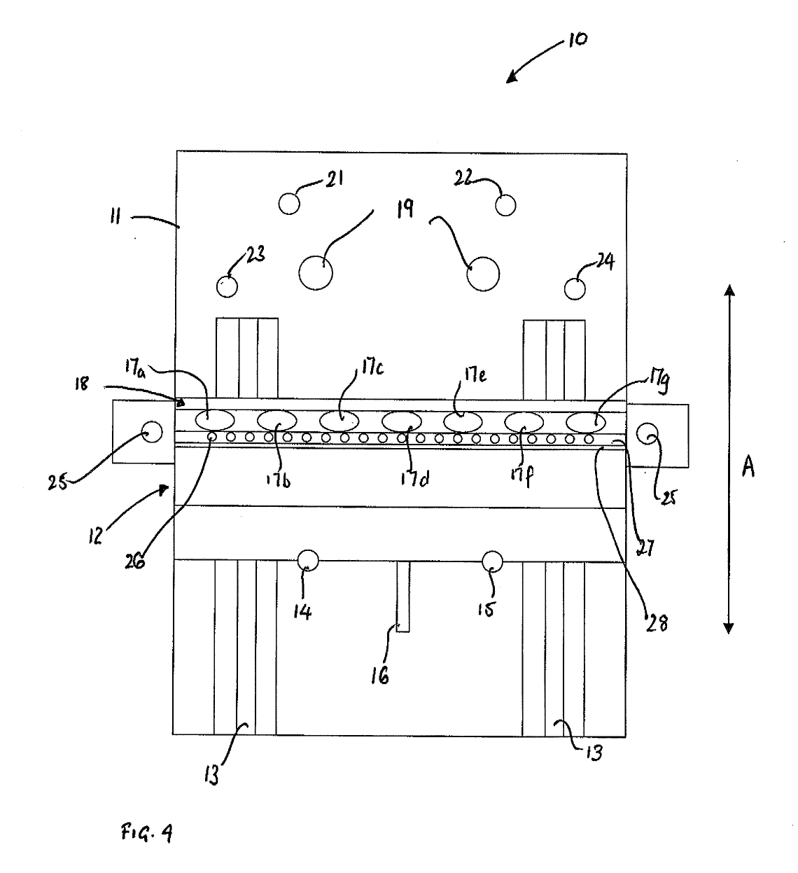

FIG. 4 is a schematic plan view of apparatus for applying a trim to a glazing, in accordance with the present invention;

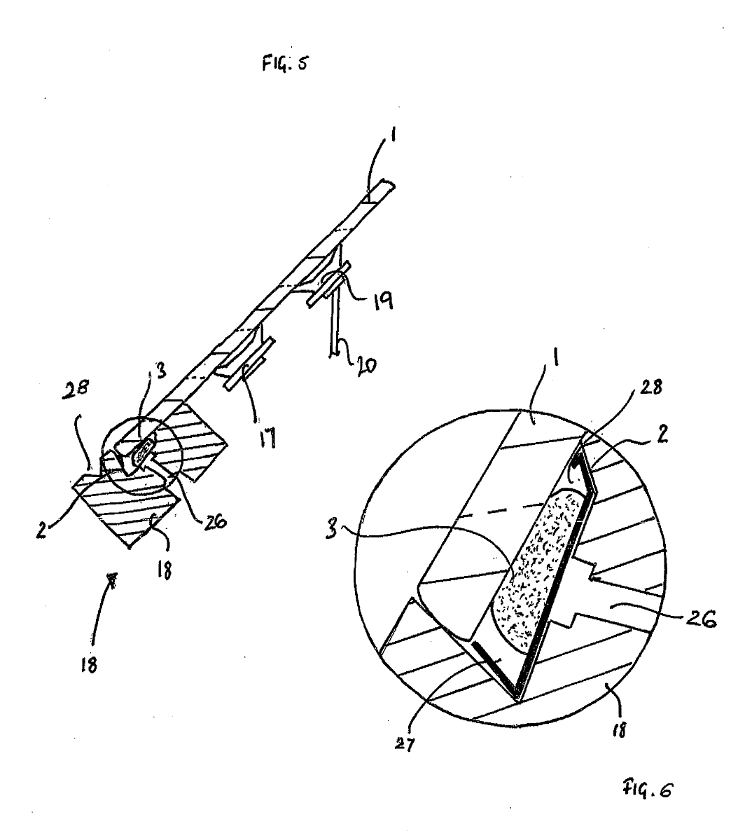

FIG. 5 is a schematic cross-section showing the positioning of the suction cups on the glazing; and

FIG. 6 is an enlarged view of the area highlighted in FIG. 5.

In the present invention, it has been appreciated that the manner in which the trim or finisher is aligned with the edge of a frameless glazing is key to ensuring that the strict tolerances between the trim/finisher and the edge of the glazing are met. By bending the edge of the glazing to which the trim/finisher is applied whilst maintaining the spatial position of the glazing, even small tolerances may be achieved.

FIG. 1 is a schematic plan view showing a frameless glazing, in this case an opening backlight, formed from a single ply of toughened glass, having a trim attached along one side. The backlight 1 is generally rectangular in shape, having rounded corners and opposing long and short sides. One of the long sides is slightly longer than the other, giving a slight trapezoidal shape to the glazing. The trim 2 is attached to the longest edge of the glazing, which will form the bottom edge of the glazing when fitted into a vehicle.

FIG. 2 a schematic cross-section along the line A-A′ in FIG. 1, and shows the positioning of the trim 2 on the edge of the frameless glazing 1. The trim 2 is generally in the shape of a “C”, with the upper part of the “C” touching the surface of the glass, and the lower part positioned at a distance d from the surface of the frameless glazing 1 adjacent the edge. The trim 2 is bonded to the lower surface of the glazing by an adhesive 3. By allowing the lower edge of the trim to be spaced apart from the edge of the glazing, any variations in the edge shape due to machining can be tolerated. However, in order to ensure that a seal is created between the glazing and the car body by the adhesive 3, as well as ensuring that there is no visible gap between the trim 2 and the frameless glazing 1, this distance d must be as small as possible. Typically, the amount of tolerance required is less than 1 mm.

The trim 2 is shown in more detail in FIG. 3. FIG. 3 is a part schematic perspective view of the trim 2, showing the four-part construction. The main body 4 of the trim 2 is formed from a thermoplastic material, such as polyurethane, and has a rough surface (indicated in part by hatched lines) to aid in the adhesion of the hot melt to the surface of the trim 2. The main body 4 is positioned within a chrome outer shell 5, which provides the aesthetic appearance of the trim 2. This chrome outer shell 5 wraps round the upper region of the trim 2. The lower region of the trim 2 is provided with a lip 6, formed from PVC (poly vinyl chloride). The end region of the trim 2 is provided with a cap 7, again formed from PVC. Both the lip 6 and cap 7 provide a cover for any hot melt material that escapes around the edges of the trim 2 when mounted on the frameless glazing 1. The lip 6 aids in reducing the final gap between the trim 2 and the glazing 1 seen by a viewer.

FIG. 4 is a schematic plan view of apparatus for applying a trim to a glazing, in accordance with the present invention. The apparatus 10 is comprises a support table 11 and manufacturing cell 12. The manufacturing cell 12 has means for locating the trim 2 onto the edge of the glazing 1 comprising runners 13 lying across the support table 11, over which the cell is slideable by means of handles 14, 15. A positioning bar 16 is provided to allow an operator to position the cell 12 for mounting of the trim 2 onto the frameless glazing 1. The cell 12 itself may be moved in the directions indicated by arrow A.

The manufacturing cell 12 itself comprises two sets of suction cups: a first set of suction cups 17a to g, arranged adjacent a former 18, which is shaped to match the curvature of the frameless glazing 1, and acts to support the frameless glazing 1 during fixing of the trim 2; and a second set of suction cups 19, positioned on supports 20 (not shown), a distance away from the former 18. When the frameless glazing 1 is placed into the manufacturing cell 12, as described below, the first set of suction cups 17a-g contact the surface of the frameless glazing 1 in the region of the edge of the frameless glazing 1, and the second set 19 contact the frameless glazing 1 away from the edge, in a central region of the frameless glazing 1. Means for supporting the glazing 1 comprising supports 21, 22, are provided to help support the weight of the glazing, which is centred using centring means comprising two posts 23, 24 and locked into position by two grips 25. Vacuum suction is provided along the length of the former 18 via an array of vacuum suction holes 26, which act to maintain the position of the trim 2 during the application process.

FIG. 5 is a schematic cross-section showing the positioning of the suction cups 17a-g, 19, on the frameless glazing 1. This Figure illustrates the position in which the suction cups 17a-g, 19 are in contact with the frameless glazing 1, and the trim 2 is in its final position, bonded to the surface of the frameless glazing 1. Although in this Figure the frameless glazing 1 is shown as being flat, in reality it is likely to have at least a minimum curvature in at least one direction. The array of vacuum suction holes 26 in the former 18 are positioned within a recess 27, into which the trim 2 is placed. A groove 28 is provided in the upper surface of the former 18, which receives a wheel for guiding an adhesive dispensing gun (not shown) during fixing of the trim 2.

FIG. 6 shows an enlarged view of the region highlighted in FIG. 4. The trim 2 rests in the recess 27, with sufficient adhesive 3 to bond the trim 2 to the frameless glazing 1 without any overflow. The distance between the lower part of the trim 2 and the surface of the frameless glazing 1 adjacent the edge is minimised.

The method by which the trim 2 is mounted onto the frameless glazing 1 will now be described.

Firstly, the frameless glazing 1 onto which the trim 2 will be mounted positioned on the supports 20-22. The frameless glazing 1 is centered using the posts 23, 24, and then secured in position using the grips 25. The second set of vacuum cups 19 are then placed onto the underside surface of the frameless glazing 1, and vacuum applied. Once the frameless glazing 1 is held in place by these suction cups 19, the grips 25 are released. At this point, the frameless glazing 1 is in a first, nominal, position placing the frameless glazing 1 in which one edge of the frameless glazing 1 is free to receive the trim 2.

The trim 2 is then prepared. The bond face of the trim 2 (the face to be contacted with the surface of the frameless glazing 1) is prepared by wiping with SIKA Activator, and left to dry. SIKA 209N primer is then applied to the bond face, and left to cure for 30 minutes. The region of the glazing where the trim 2 will be bonded is also prepared by wiping with SIKA Activator (wipe-on, wipe-off).

A prepared trim 2 is then placed in the recess 27 of the former 18, and vacuum applied via vacuum suction holes 26. An adhesive dosing gun is then run along the groove 28 to apply a bead of SIKAMELT 9645/15 black hot melt adhesive, (having a maximum time before bonding of 40 seconds, at a temperature in the range 120° C. to 170° C.). The adhesive was applied at 150° C. and 2 Bar, taking 25 seconds. (SIKA-branded products are available from Sika AG, Zugerstrasse 50, CH-6341 Baar, Switzerland). As alternatives to applying a single bead of adhesive along the length of the trim 2, a plurality of small beads may be applied, or adhesive may only be applied to selected portions of the trim 2.

Once the adhesive has been applied, the former 18 is moved along the runners 13 until the trim 2 is in contact with the frameless glazing 1. A gap of approximately 1 mm is left between the bottom edge of the trim 2 and the frameless glazing 1. The first set of suction cups 17a-g are then positioned against the underside surface of the frameless glazing 1, and a vacuum applied, pushing the frameless glazing into a second position and causing the glazing to deform against the trim 2, minimising the gap between the bottom edge of the trim 2 and the frameless glazing 1. The frameless glazing 1 is then held in this position for up to 120 seconds to allow sufficient curing of the hot melt adhesive such that the trim 2 remains in place once the vacuum cups 17a-g have been removed. The frameless glazing 1 having the trim 2 attached can then be removed from the apparatus 10, and the hot melt will be fully cured within 4 hours.

When this method was carried out on a frameless glazing 1 (a backlight), the final gap d between the bottom edge of the trim 2 and the frameless glazing 1 was approximately 0.4 mm at the ends of the trim 2, and between 0 and 0.1 mm along the remainder of the trim 2.

Although in the above method, a hot melt material is used as the adhesive, other suitable adhesives may be used instead. These may include humidity curing polymers, and pre-applied adhesives, where the adhesive is applied to the trim 2 in the form of a number of tablets or a continuous strip, and protected by a removable cover sheet.

1. A method of bonding a trim onto the edge of a frameless automotive glazing using an adhesive, comprising:
placing the glazing in a first position in which an edge of the glazing is free to receive a trim;
locating a trim having adhesive applied to at least a portion thereof in contact with the glazing;
pushing the glazing into a second position, deforming the glazing against the trim and the adhesive such that the trim bonds to the glazing.

2. The method of claim 1, wherein the adhesive is pre-applied to the trim.

3. The method of claim 1, further comprising locating the trim in the region of the glazing, and applying the adhesive to the trim before locating the trim in contact with the glazing.

4. The method of claim 1, wherein the glazing is held in the first position by a applying a first set of vacuum suction cups.

5. The method of claim 1, wherein the glazing is pushed into the second position by applying a second set of vacuum cups.

6. The method of claim 3, wherein the adhesive is a hot melt adhesive.

7. The method of claim 1, wherein the trim is held in position in contact with the glazing by vacuum suction.

8. The method of claim 1, wherein the glazing is a single-ply of glass.

9. A frameless automotive glazing having a trim applied thereon using the method of claim 1.

10. An apparatus for applying a trim to the edge a frameless automotive glazing, comprising:
means for supporting and centering a frameless automotive glazing possessing an underside;
at least one suction cup forming a first set for applying vacuum suction to the underside of the glazing to hold the glazing in a first position;
at least one suction cup forming a second set for applying vacuum suction to the underside of the glazing to push the glazing into a second position;
a recess for receiving a trim, the recess being provided with a plurality of vacuum suction holes for maintaining a position of the trim; and
means for locating the trim onto the edge of the glazing.

11. The method of claim 2, wherein the glazing is held in the first position by a applying a first set of vacuum suction cups.

12. The method of claim 3, wherein the glazing is held in the first position by a applying a first set of vacuum suction cups.

13. The method of claim 2, wherein the glazing is pushed into the second position by applying a second set of vacuum cups.

14. The method of claim 3, wherein the glazing is pushed into the second position by applying a second set of vacuum cups.

15. The method of claim 3, wherein the glazing is a single-ply of glass.

16. The method of claim 4, wherein the adhesive is a hot melt adhesive.

17. The method of claim 5, wherein the adhesive is a hot melt adhesive.

18. The method of claim 2, wherein the trim is held in position in contact with the glazing by vacuum suction.

19. The method of claim 3, wherein the trim is held in position in contact with the glazing by vacuum suction.

20. The method of claim 2, wherein the glazing is a single-ply of glass.
